(19) United States
(12) Patent Application Publication
(10) Pub. No.: US 2026/0309159 A1
(43) Pub. Date: Oct. 8, 2026

(54) CENTRIFUGAL AIR BLOWER

(71) Applicant: SHINANO KENSHI KABUSHIKI KAISHA, Nagano (JP)

(72) Inventor: Masahiko UNI, Nagano (JP)

(21) Appl. No.: 19/549,109

(22) Filed: Feb. 25, 2026

(30) Foreign Application Priority Data
Apr. 3, 2025 (JP) 2025-061734

(51) Int. Cl. F04D 17/08; F04D 29/44; B60N 2/56

(52) U.S. Cl. CPC F04D 17/08; F04D 29/441; B60N 2/5621

(57) ABSTRACT

There is provided an easy-to-handle and highly reliable centrifugal air blower which is small and flat, achieves sufficient air flow and static pressure, and is quite in operation. A first case and a second case combine to form an annular air passage around a radial outside of the case body. An inner circumferential surface of a first air passage is provided with a first diffuser inclined diagonally downward from an inside in the radial direction toward an outside. A plurality of exhaust holes, which expel compressed air outside the case body, are formed in a bottom of the second air passage at predetermined intervals around the circumference. A second diffuser that is inclined diagonally downward with respect to a direction of rotation of the centrifugal fan is provided at positions facing the exhaust holes.

### CROSS-REFERENCE TO RELATED APPLICATION

This application is based upon and claims the benefit of priority of the prior Japanese Patent Application No. 2025-061734, filed on Apr. 3, 2025, and the entire contents of which are incorporated herein by reference.

### TECHNICAL FIELD

The present disclosure relates to a centrifugal air blower used for example in a seat air conditioning or HVAC (Heating, Ventilation, and Air Conditioning) equipment.

### BACKGROUND ART

When a driver is in contact with the seat backrest or a seat cushion for a long period of time, such as when driving a car a long distance, hot and humid air will linger around the driver, causing discomfort. For this reason, seat air conditioners are used to condition the hot and humid air that tends to accumulate near a seat backrest and a seat cushion.

Seat air conditioners include conditioners that expel air from the seat and conditioners that draw in air from the seat and expel such air elsewhere. The description here focuses on suction-type seat air conditioners, which are expected to provide a more comfortable air conditioning effect. Suction-type seat air conditioners achieve an air conditioning effect by drawing in hot and humid air that lingers at the seat backrest and seat cushion parts to remove such air from those areas.

As one example, a seat air conditioning system has been proposed that suppresses the noise generation when air is drawn from the seat into the intake port of a blower. Such intake port is formed in an upper case of a case produced by combining the upper case and a lower case with screws at the four corners. A motor, which includes a stator and a rotor, and a centrifugal multi-bladed fan are rotatably supported in the lower case. The rotor is integrally combined with the centrifugal multi-bladed fan. When the motor rotates and the centrifugal multi-bladed fan rotates, air is drawn in from the seat through the intake port in the upper case and is expelled through outlet openings provided on all four sides of the case (see Patent Document 1: Japanese Laid-open Patent Publication No. 2015-174580).

### SUMMARY OF INVENTION

### Technical Problem

In the configuration of Patent Document 1 cited above, since the case is open on all four sides, its rigidity is extremely low. This results in a risk of handling and reliability issues, such as durability against stress and loads that act on the seat and issues relating to ease of assembly. In more detail, if tension acts on cables, such as signal lines and power feeder lines connected to the motor substrate, such cables may break, causing a drop in reliability. Even if ribs or the like are provided to increase the rigidity of the case, this would lead to an increase in cost and would require a creative solution for fixing lead wires, which makes handling more difficult. Centrifugal air blowers, such as those used in vehicles for example, need to be small and flat, to achieve a sufficient air flow and static pressure, and to be quiet in operation.

### Solution to Problem

The present disclosure was conceived to solve the problems described above and has an object of providing a centrifugal air blower that is easy to handle and is highly reliable while being small and flat, achieves a sufficient air flow and static pressure, and is also quiet in operation.

To achieve the object stated above, the present disclosure has the following configuration. A centrifugal air blower has a centrifugal fan and a motor that rotationally drives the centrifugal fan housed inside a case body, and draws in air from a center in an axial direction of the case body and expels the air from a bottom on an outside in a radial direction of the case body, the case body including: a first case that is assembled to cover the centrifugal fan, has an intake opening provided at a center thereof, and has a first air passage formed at an outside in the radial direction; and a second case that rotatably supports the motor and has a second air passage that is combined with the first air passage and is formed radially outward of an outer circumferential end of the centrifugal fan, wherein the motor is housed in a dome-shaped space formed on an opposite side to an intake opening by a hub of the centrifugal fan and a main plate that is continuous with the hub, in a state where the motor is stacked in the axial direction, the first case and the second case combine to form an annular air passage around an outside in the radial direction of the case body, an inner circumferential surface of the first air passage is provided with a first diffuser that is inclined diagonally downward from an inside in the radial direction toward an outside, a plurality of exhaust holes, which expel compressed air outside the case body, are formed in a bottom of the second air passage at predetermined intervals in a circumferential direction, and a second diffuser that is inclined diagonally downward with respect to a direction of rotation of the centrifugal fan is provided at positions that face the exhaust holes.

With the configuration described above, out of the annular air flow passage, the inner surface of the first air flow passage is provided with a first diffuser that is inclined diagonally downward from the inside to the outside in the radial direction, and a second diffuser is provided at positions facing the exhaust holes formed in the bottom of the second air flow passage so as to be inclined diagonally downward with respect to the direction of rotation of the centrifugal fan. As a result, static pressure can be increased even if the exhaust flow path from the centrifugal fan to the exhaust holes is short, and a sufficient air flow rate can be achieved even when a load is applied. In particular, due to the combined effects of the first diffuser and the second diffuser, static pressure can be increased even at low exhaust flow rates. The case body, which houses the centrifugal fan and the motor that rotationally drives the centrifugal fan, is formed by combining the first case, which has the intake opening provided in the center and the first air passage formed on the outside in the radial direction, with the second case, which rotatably supports the motor and has the second air passage that is combined with the first air passage and is formed on the outside in the radial direction, which means that the case body has high rigidity and is also easy to handle. In particular, since the plurality of exhaust holes that expel compressed air to the outside of the case body are formed at predetermined intervals around the circumference at the bottom of the second air passage, the side surfaces of the case body can be closed off, thereby improving the strength of the case body. In addition, since the motor is housed by being stacked in the axial direction inside a dome-shaped space formed on the opposite side to the intake opening by the hub of the centrifugal fan and the main plate that is continuous with the hub, the dimension in the axial direction of the centrifugal air blower is reduced, allowing for a smaller and flatter centrifugal air blower of the same rating. In addition, by increasing the outer diameter of the centrifugal fan and expanding the areas of the intake opening and the exhaust holes, it is possible to make the fan smaller and flatter in the axial direction, and to increase the flow rate even at low rotational speeds. Additionally, since the annular air passage formed around the outside in the radial direction of the case body does not have a partition wall called a "tongue", peak noise is not generated, which also makes the blower quieter.

It is preferable for an inner wall surface of the first air passage, which defines the first air passage, to be formed with an inclined surface that is inclined diagonally downward from an inside in the radial direction toward an outside, and for the first diffuser to be formed with continuous arc-shaped ribs at predetermined intervals whose height gradually increases from a first imaginary circle that defines, in a plan view of the first case, an inner end in the radial direction of the inclined surface toward a second imaginary circle that defines an outer end in the radial direction of the inclined surface.

With this configuration, air drawn in through the intake opening by rotation of the centrifugal fan can be diffused by the first diffuser while guiding such air into the first air passage. Since the height of the ribs, which are connected in arc shapes gradually increases from the inner end in the radial direction to the outer end, it is possible to disperse the locations where peak noise of a frequency component obtained by multiplying the number of blades on the impeller by the rotational frequency occurs, thereby reducing noise.

It is preferable for each rib to be formed so that an angle θ formed between a first tangent line, which passes through an intersection where a radius of the first case and the first imaginary circle intersect, and a second tangent line, which is tangential to a rib that is arc-shaped and connects the intersection on the first imaginary circle and the second imaginary circle, is 0° to 90°.

With this configuration, it is possible to diffuse air drawn into the case body through the intake opening of the first case by rotation of the centrifugal fan with the plurality of arc-shaped ribs and guide such air into the first air passage, thereby increasing the static pressure in a range of low flow rates.

It is preferable for diffusion plates that construct the second diffuser to be disposed so that diffusion plates that are adjacent in the circumferential direction do not overlap each other in a plan view in the axial direction of the second case, and for the diffusion plates to have a curved shape where a downstream end in a direction in which air is exhausted is shifted by a predetermined amount in the direction of rotation of the centrifugal fan so that air is exhausted in keeping with rotation of the centrifugal fan.

With this configuration, since a plurality of diffusion plates are disposed so that diffusion plates that are adjacent in the circumferential direction do not overlap each other in a plan view in the axial direction, it is possible to achieve the required air flow even with a small and flat configuration. Compared to a configuration where the second diffuser is not provided, the static pressure can be increased even when the exhaust flow path from the centrifugal fan to the exhaust port is short.

### Advantageous Effects of Invention

The centrifugal air blower described above is easy to handle and highly reliable while being small and flat, achieves a sufficient air flow and static pressure, and is also quiet in operation.

### BRIEF DESCRIPTION OF DRAWINGS

FIG. 1 is a perspective view of a centrifugal air blower.

FIG. 2 is a perspective view of a state where a first case of the centrifugal air blower in FIG. 1 has been removed.

FIG. 3 is a cross-sectional view, in an axial direction, of the centrifugal air blower in FIG. 1.

FIG. 4 is a plan view of an inner surface side of the second case.

FIG. 5 is a perspective view of the inner surface side of the second case.

FIG. 6 is a perspective view of an inner surface side of the first case.

FIG. 7 is a partially enlarged perspective view of the first case in FIG. 6.

FIG. 8 is a plan view of the inner surface side of the first case.

FIG. 9 is a graph depicting air flow – static pressure characteristics in keeping with the presence or absence of a diffuser on an inner surface of the first case of a centrifugal air blower.

FIG. 10A is a perspective view of an inner surface side of a first case where a diffuser is not provided on the inner surface, and FIGS. 10B to 10F are perspective views of an inner surface side of a first case that has a diffuser provided on the inner surface, for configurations where an angle θ (or "entry angle") between a first tangent line L1 and a second tangent line L2 of ribs that construct a diffuser is changed in 30° increments between 0° and 120°.

FIG. 11A is a graph indicating noise levels in keeping with changes in the entry angle of the ribs on the first case of a centrifugal air blower, and FIG. 11B is a graph indicating static pressure characteristics in keeping with changes in the entry angle of the ribs on the first case of a centrifugal air blower.

### DESCRIPTION OF EMBODIMENTS

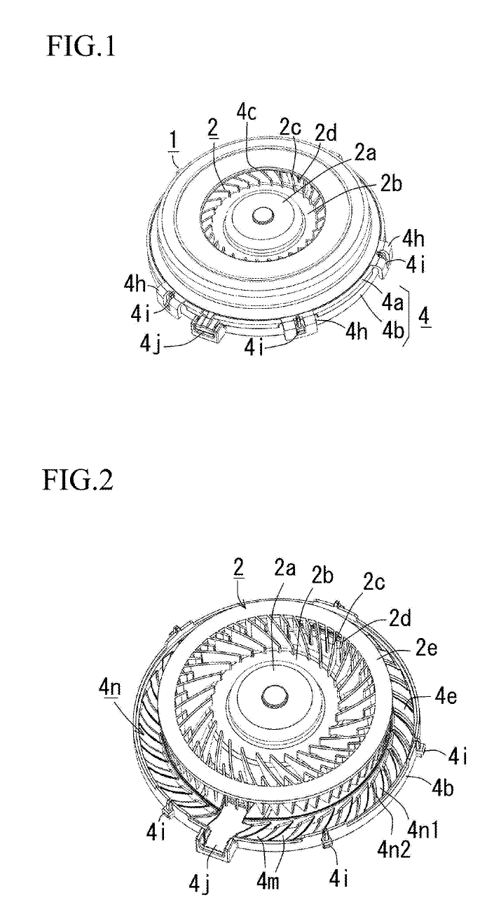

An embodiment of a centrifugal air blower according to the present disclosure will now be described with reference to the accompanying drawings. First, the overall configuration of a centrifugal air blower will be described with reference to FIG. 1 to FIG. 8. A DC brushless motor is used as the motor M. In the present embodiment, an outer rotor motor is used. Note that an inner rotor motor may also be used.

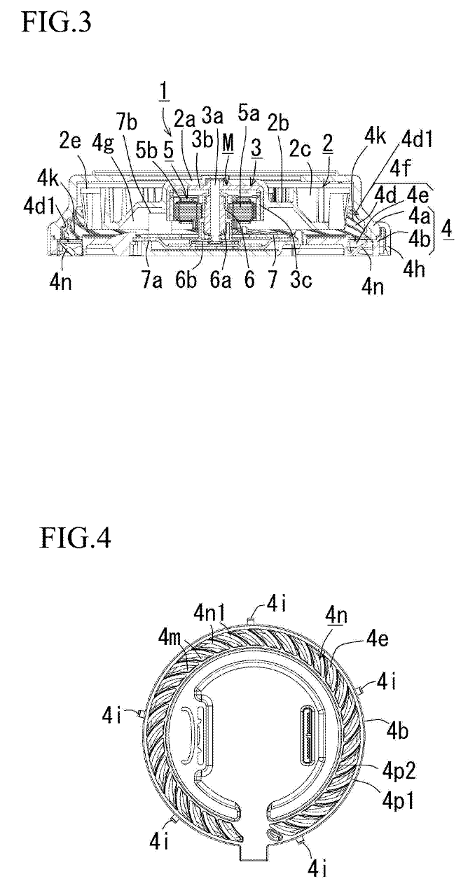

As depicted in FIG. 3, the centrifugal air blower 1 is configured with a motor M, which rotationally drives a centrifugal fan 2 and a rotor 3 that are integrally assembled, housed inside a case body 4. As depicted in FIG. 1, the centrifugal air blower 1 draws air in from the center in the axial direction of the case body 4 and expels pressurized air in the axial direction from the outside in the radial direction. The case body 4 is formed by combining a first case 4a, which is assembled to cover the centrifugal fan 2, and a second case 4b, which rotatably supports the motor M (that is, a rotor 3 and a stator 5: see FIG. 3).

As depicted in FIG. 1, an intake opening 4c is provided in the center of the first case 4a, and a first air passage 4d is formed on the outside in the radial direction of the case 4a as depicted in FIG. 3. As depicted in FIG. 2, a second air passage 4e that is combined with the first air passage 4d is formed on the outside in the radial direction of the second case 4b. By combining the first case 4a and the second case 4b, an annular air passage 4f is formed on the outside in the radial direction of the case body 4.

As depicted in FIG. 3, a bearing holder 6 and a motor substrate 7 are assembled in the center of the second case 4b. A stator core 5a is integrally fixed to the outer circumference of the bearing holder 6, and a rotor shaft 3a is rotatably supported via a bearing 6a in the shaft hole of the bearing holder 6. A stator coil 5b is wound around pole teeth formed on the stator core 5a, and the front ends of the pole teeth are disposed facing a rotor magnet 3c. The motor substrate 7 is equipped with a Hall sensor or the like to which a lead wire of the stator coil 5b is connected and which detects the position of the rotor magnet 3c. If the motor M is a sensorless type, such position detection sensor can be omitted. One end of the rotor shaft 3a is integrally attached to the hub of the cup-shaped rotor yoke 3b by press-fitting, shrink-fitting, adhesive bonding, or a combination of such methods. The other end of the rotor shaft 3a is supported by a shaft support 6b provided inside the bearing holder 6. The shaft support 6b is supported by a substrate support 7a that supports the motor substrate 7. The rotor magnet 3c is integrally attached to an inner circumferential surface of the rotor yoke 3b. Note that the center of the intake opening 4c does not need to precisely match the axis of the rotor shaft 3a of the motor M, and it is sufficient for the intake opening 4c to be positioned near the center in the axial direction of the case body 4 within a range where the centrifugal fan 2 can operate without a drop in efficiency.

As depicted in FIG. 2, the centrifugal fan 2 has a dome-shaped main plate 2b which extends outward in the radial direction from the hub 2a. The main plate 2b, which is continuous with the hub 2a, extends so as to be inclined to the downstream side in the direction of airflow toward the outside in the radial direction. A plurality of curved impellers 2c are erected on the main plate 2b and extend from the inside toward the outside in the radial direction. Auxiliary impellers 2d are erected near the outsides (the outer circumferential edges) in the radial direction of the impellers 2c, which are erected on the main plate 2b that is continuous with the hub 2a, at equal intervals from the adjacent impellers 2c (that is, in the center between adjacent impellers 2c). By doing so, pulsations in pressure at each blade are reduced, which suppresses peak noise due to interference with the diffuser. Air that has been drawn in through the intake opening 4c that faces the hub 2a of the centrifugal fan 2 is pressurized and directed by the impellers 2c and the auxiliary impellers 2d, which are formed on the main plate 2b, toward the annular airflow passage 4f located at the outside in the radial direction. An annular shroud 2e is connected to the outer circumferential edges of the impellers 2c and the auxiliary impellers 2d, and regulates and directs pressurized air from the impellers 2c and the auxiliary impellers 2d toward the annular air passage 4f (see FIG. 3) located on the outside.

As depicted in FIG. 3, the hub 2a of the centrifugal fan 2 and the main plate 2b connected to the hub 2a form a dome-shaped space 4g on the opposite side to the intake opening 4c. This dome-shaped space 4g can be used to house the motor M and tall components (such as an electrolytic capacitor 7b) mounted on the motor substrate 7, which enables the centrifugal fan 2 and the motor M to be assembled in a compact arrangement. The rotor 3 and the stator 5 of the motor M are housed in the dome-shaped space 4g so as to be stacked in the axial direction. By doing so, the axial dimension of the centrifugal air blower 1 can be reduced, which makes it possible to achieve a smaller and flatter centrifugal air blower 1 of the same rating.

As depicted in FIG. 1, the first case 4a and the second case 4b are integrally assembled by placing them together with their openings facing each other and engaging locking pieces 4h provided on the outer circumference of sides of the first case 4a with locking portions 4i provided on the outer circumference of sides of the second case 4b. The first case 4a and the second case 4b are formed with a wiring connection port 4j through which wiring connected to the motor substrate 7 is routed to the outside of the case.

As depicted in FIG. 3, the side surface of the first case 4a, which is continuous with an upper surface of the first case 4a in which the intake opening 4c is provided, form the first air passage 4d. The inside of this side surface is formed with an inclined surface 4d1, which is inclined diagonally downward from the inside in the radial direction toward the outside. A first diffuser 4k is formed on the inclined surface 4d1 from the inside in the radial direction toward the outside.

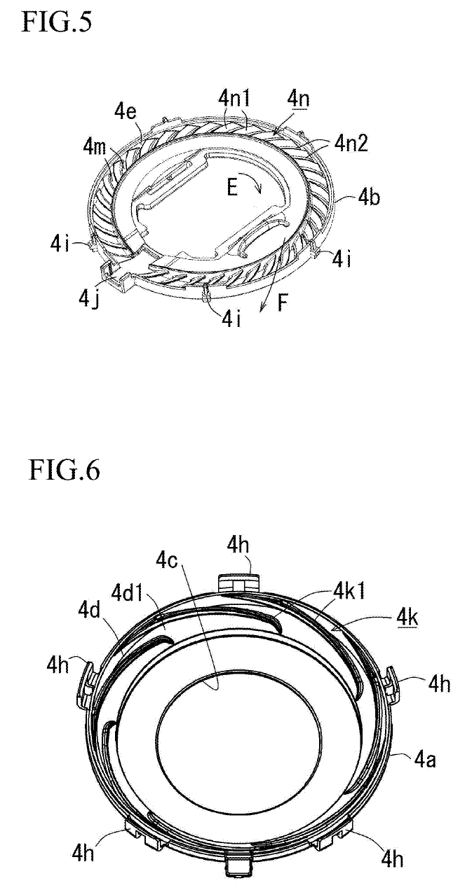

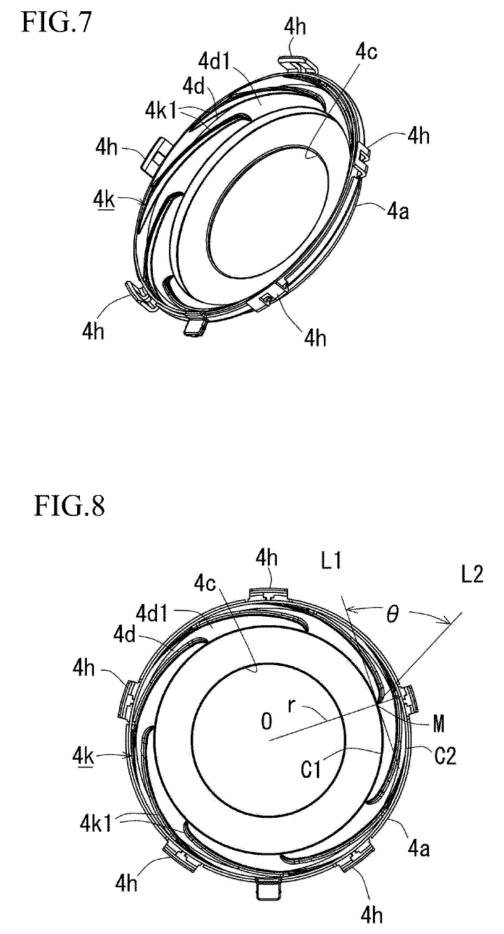

As depicted in FIGS. 6 and 7, the first diffuser 4k is formed on the inclined surface 4d1 provided on the side surface of the first case 4a. In more detail, the inclined surface 4d1 is formed with a plurality of arc-shaped ribs 4k1 at predetermined intervals whose height gradually increases from the inside in the radial direction toward the outside.

FIG. 8 is a plan view of the inside of the first case 4a. As depicted in FIG. 8, the center of the intake opening 4c of the first case 4a is indicated as "O", and the radius of the first case 4a that extends radially outward from the center O is indicated as "r". Here, when the inner surface of the first case 4a is viewed in a plan view, a first imaginary circle C1 corresponding to the inner end in the radial direction and a second imaginary circle C2 that is concentric and corresponds to the outer end in the radial direction are formed on the inclined surface 4d1. The plurality of ribs 4k1 are formed in arc shapes to connect the first imaginary circle C1 and the second imaginary circle C2.

As depicted in FIG. 8, an intersection where the first imaginary circle C1 intersects a radius r of the first case 4a is set as "M", and the tangent to the first imaginary circle C1 passing through this intersection point M is set as a "first tangent line L1". A tangent to an arc-shaped rib 4k1 that passes through this intersection M on the first imaginary circle C1 is set as a "second tangent line L2". Each rib 4k1 is provided so that the angle θ (or "entry angle") between the first tangent line L1 and the second tangent line L2 is between 0° and 90°. FIG. 8 depicts an example configuration where the entry angle θ of the ribs 4k1 is 60° (the same as in FIGS. 6 and 7). A plurality of ribs 4k1 are formed at predetermined intervals in the circumferential direction on the inclined surface 4d1. Note that the plurality of ribs 4k1 are integrally formed during resin molding of the first case body 4a. The form of the first diffuser 4k is not limited to ribs and may be composed of plate-like shapes, such as diffusion plates.

With this configuration, air drawn into the case through the intake opening 4c of the first case 4a by the rotation of the centrifugal fan 2 can be diffused by the ribs 4k1 that construct the first diffuser 4k, while increasing the static pressure and guiding such air into the first air passage 4d. Since the height of the ribs 4k1, which are connected in arc shapes gradually increases from the inside in the radial direction to the outside of the inclined surface 4d1 of the first case 4a, it is possible to disperse the locations where peak noise of a frequency component obtained by multiplying the number of blades on the impeller 2 by the rotational frequency occurs, thereby reducing noise.

As depicted in FIG. 4, exhaust holes 4m that exhaust compressed air, which has been pressurized, in the axial direction are provided at a plurality of locations in the circumferential direction on the outer periphery of the bottom of the second case 4b, which forms the second air passage 4e. The exhaust holes 4m are formed so as to be partitioned by a plurality of diffusion plates 4n1 that construct the second diffuser 4n provided on the bottom of the second case 4b. Each diffuser plate 4n1 is installed between a bottom outer peripheral wall 4p1 and a bottom inner peripheral wall 4p2. The plurality of diffusion plates 4n1 are disposed so that adjacent diffusion plates 4n1 do not overlap each other in a plan view in the axial direction.

In more detail, as depicted in FIG. 5, the plurality of diffusion plates 4n1 that construct the second diffuser 4n have curved shapes with curved surfaces where downstream ends in the exhaust direction are shifted by a predetermined amount in the direction of rotation E of the centrifugal fan 2 so that exhausted air follows the rotation of the centrifugal fan 2 in the direction indicated by the arrow. The exhaust holes 4m are formed between adjacent diffusion plates 4n1. It is preferable for the corners 4n2 of end surfaces of the diffusion plates 4n1 that face the exhaust holes 4m to be chamfered. When an inner surface of the second case 4b is viewed in a plan view, each diffuser plate 4n1 is connected in an arc shape between the bottom inner peripheral wall 4p2 and the bottom outer peripheral wall 4p1 and is provided in an inclined posture that faces diagonally downward. The second diffuser 4n expels the air to be exhausted in the axial direction from the exhaust holes 4m provided in the second air passage 4e diagonally downward relative to the direction of rotation of the centrifugal fan 2 along the inclination of the diffuser plates 4n1 as indicated by the arrow F in FIG. 5.

By doing so, the plurality of diffusion plates 4n1 are disposed so that diffusion plates 4n1 that are adjacent in the circumferential direction do not overlap each other in a plan view in the axial direction, which enables the required air flow to be achieved even with a small, flat design and achieves higher static pressure even when the exhaust flow path from the centrifugal fan 2 to the exhaust holes 4m is shorter than a configuration where the second diffuser 4n is not provided.

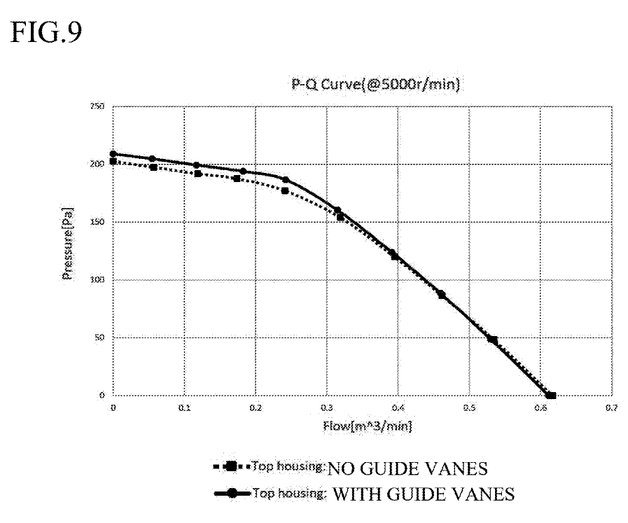

FIG. 9 is a graph depicting the air flow-static pressure characteristics (P-Q characteristics) for a configuration where only the second diffuser 4n is provided in the second case 4b and a configuration where the first diffuser 4k is provided in the first case 4a and the second diffuser 4n is provided in the second case 4b. The graph drawn with a solid line indicates the airflow-static pressure characteristics (P-Q characteristics) when the first diffuser 4k is provided in the first case 4a and the second diffuser 4n is provided in the second case 4b. The graph drawn with a broken line indicates the airflow-static pressure characteristics (P-Q characteristics) when only the second diffuser 4n is provided in the second case 4b. These graphs demonstrate that providing the first diffuser 4k in the first case 4a (the solid line graph) increases the static pressure in a range of low flow rates compared to when the first diffuser 4k is not provided in the first case 4a (the broken line graph).

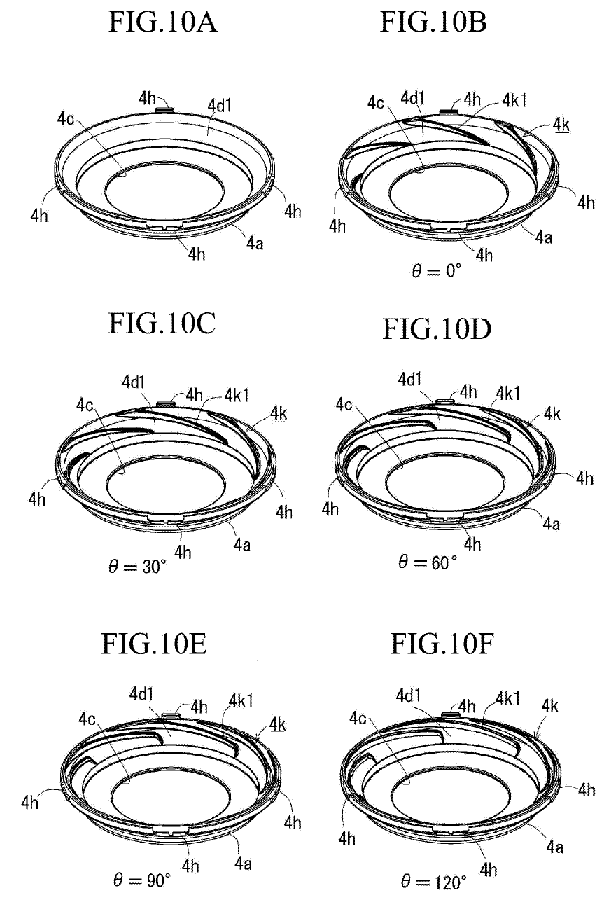

FIG. 10A is a perspective view of the inner surface side of a first case 4a where the first diffuser 4k is not provided (see FIG. 8). FIGS. 10B to 10F are perspective views of the inner surface side of a first case 4a provided with the first diffuser 4k. FIGS. 10B to 10F depict configurations where the angle θ (the entry angle; see FIG. 8) between the first tangent L1 and the second tangent L2 of the ribs 4k1 that construct the first diffuser 4k is changed in 30° increments between 0° and 120°. Six types of centrifugal fans 1 with different inner surface configurations for the first case 4a were prepared, and a microphone was placed 1 m away from the intake port 4c to evaluate fan noise under a condition where the airflow rate of each centrifugal fan 1 was the same. The static pressure characteristics (so-called "P-Q characteristics") at different fan flow rates were also evaluated separately.

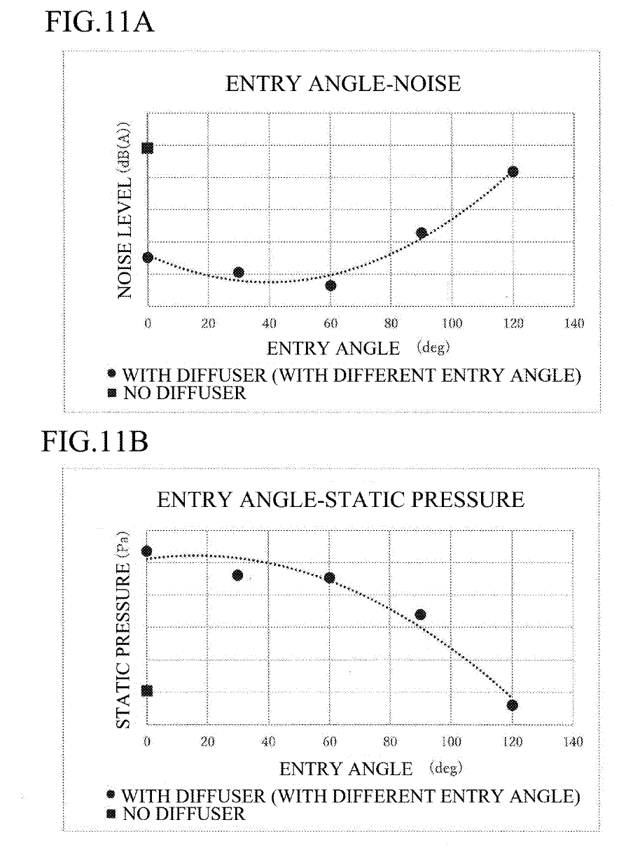

The measurement results are depicted in FIGS. 11A and 11B. As can be understood from the graph in FIG. 11A, when the first diffuser 4k is provided on the first case 4a, fan noise can be suppressed at the same flow rate when the entry angle of the ribs 4k1 that construct the first diffuser 4k is between 0° and 90°. As can be understood from the graph in FIG. 11B, when a first diffuser 4k is provided on the first case 4a, the static pressure at the same flow rate also increases when the entry angle of the ribs 4k1 is between 0° and 90°.

As described above, out of the annular air flow passage 4f, the inner surface of the first air flow passage 4d is provided with a first diffuser 4k that has a plurality of diffusion plates that are inclined diagonally downward from the inside to the outside in the radial direction, and a second diffuser 4n is provided at positions facing each exhaust hole 4m formed in the bottom of the second air flow passage 4e so as to be inclined diagonally downward with respect to the direction of rotation of the centrifugal fan. As a result, static pressure can be increased even if the exhaust flow path from the centrifugal fan 2 to the exhaust holes 4m is short, and a sufficient air flow rate can be achieved even when a load is applied. In particular, due to the combined effects of the first diffuser 4k and the second diffuser 4n, static pressure can be increased even at low exhaust flow rates. The case body 4, which houses the centrifugal fan 2 and the motor M that rotationally drives the centrifugal fan 2, is formed by combining the first case 4a, which has the intake opening 4c provided in the center and the first air passage 4d formed on the outside in the radial direction, with the second case 4e, which rotatably supports the motor M and has the second air passage 4e that is formed on the outside in the radial direction and combines with the first air passage 4d, which means that the case body 4 has high rigidity and is also easy to handle. In particular, since the plurality of exhaust holes 4m that expel compressed air to the outside of the case body 4 are formed at predetermined intervals around the circumference at the bottom of the second air passage 4e, the side surfaces of the case body 4 can be closed off, thereby improving the strength of the case body 4. The motor M is housed by being stacked in the axial direction inside the dome-shaped space 4g formed on the opposite side to the intake opening 4c by the hub 2a of the centrifugal fan 2 and the main plate 2b that is continuous with the hub 2a. This reduces the dimension in the axial direction of the centrifugal air blower 1, allowing for a smaller and flatter centrifugal air blower of the same rating. In addition, by increasing the outer diameter of the centrifugal fan 2 and expanding the areas of the intake opening 4c and the exhaust holes 4m, it is possible to make the fan smaller and flatter in the axial direction, and to increase the flow rate even at low rotational speeds. Additionally, since the annular air passage 4f formed around the outside in the radial direction of the case body 4 does not have a partition wall called a "tongue", peak noise is not generated, which also makes the blower quieter.

The effect of the centrifugal air blower 1 according to the present disclosure in vehicle air conditioning will be described here in detail. When the centrifugal air blower 1 is attached to a vehicle seat for suction-type seat air conditioning, the noise generated during the operation of the centrifugal air blower 1, that is, "the centrifugal fan 2 rotating to draw in air from the axial direction, generating an airflow toward the outside within the case body 4, changing the air direction near the outer periphery within the case body 4, and exhausting the air in the opposite direction to the intake direction at the outer periphery", accounts for a large proportion of the noise generated by seat air conditioning as a whole. Since the flow path from an intake port at the seat surface to the centrifugal air blower 1 is short and the exhaust port of the centrifugal air blower 1 has a flow path cross-sectional area that is ample relative to the exhaust flow rate, there are limited factors for generation of noise aside from the blower itself. Accordingly, it is possible to clearly distinguish noise caused by the centrifugal air blower 1 from noise due to causes aside from the blower. Since the noise-generating factors and characteristics such as output of the centrifugal air blower 1 are contained within the case body 4, the blower characteristics (such as output and noise) are consistent. Also, since the case body 4 is highly rigid as described earlier, there is a high degree for freedom for the attachment position and shape of the seat to which the centrifugal air blower 1 is attached, making this configuration applicable to a wide variety of seats and achieving cost reductions through mass production. By achieving stable characteristics (such as output and noise), the accuracy of simulations into the characteristics of seat air conditioning, for the purpose of passenger comfort, can be improved from the vehicle design stage, which has a secondary effect of reducing the time and effort spent by vehicle manufacturers on design. Compared to the suction-type seat air conditioning disclosed in the related art document cited earlier (Patent Document 1: Japanese Laid-open Patent Publication No. 2015-174580), the centrifugal air blower 1 according to the present disclosure has an effect of enabling seats to be made smaller. Unlike the present disclosure, the blower disclosed in Patent Document 1 directs exhaust air (outwardly) in the radial direction of a rotating shaft. As mentioned earlier, this raises concerns about the blower durability against mechanical stress, which necessitates a mechanically robust design resulting in increased size and/or weight. In addition, since the exhaust air must be processed at the rear of the seat (the rear in the case of a back rest, or below in the case of a seat cushion), the blower must be equipped with a connector to an in-seat duct or an outlet at the rear of the back rest, which further increases size and weight. In contrast, the centrifugal air blower 1 can exhaust air directly from the rear of the back rest through the seat covering, and by having high rigidity and omitting additional parts can be made smaller than the centrifugal air blower according to Patent Document 1. Vehicle seats have conventionally not included components such as blowers for air conditioning, so that a seat equipped with a blower will essentially have a foreign object present within the seat cushion. To prevent seated passengers from experiencing the blower as a foreign object, the blower must be made smaller or the seat cushion must be made thicker. In view of the recent trend toward lighter and more compact vehicles, the centrifugal air blower 1 according to the present disclosure will clearly have a suitable effect for this trend.

Although the above embodiment has been described by way of an example of a vehicle-mounted seat air conditioner, the present invention is not limited to this and may also be used for a centrifugal air blower for HVAC (heating, ventilation, and air conditioning) use. As one example, the centrifugal air blower 1 according to the present disclosure can also be used in vehicle HVAC systems aside from seat air conditioners. In the past, air conditioning blowers (such as those with a scroll-shaped casing with a tongue) have been disposed in unused spaces in automobiles. However, due to developments such as reductions in car size and cabin spaces being enlarged, there has been a reduction in unused space. Electric vehicles also have different body structures from conventional automobiles. Such developments mean that securing space for placing blowers for air conditioning has become a headache for automobile designers. By using a blower like the centrifugal air blower 1 according to the present disclosure with features such as a thin profile, high pressure, and the ability to draw in and expel air in the same direction, an increased degree of freedom can be achieved for automobile design. In conventional automobiles, HVAC-related devices tend to be clustered around knee height in front of the front seats due to the installed locations of the blowers. However, the centrifugal air blower 1 enables a plurality of blowers to be distributed throughout an automobile and placed on the ceiling, side walls, doors, and the like. By combining the centrifugal air blower 1 with a thermoelectric element such as a Peltier element, it is possible to realize a space-saving distributed air conditioning system, which also contributes to automobile design that makes highly efficient use of space. It should be obvious, but the present disclosure is similarly effective in fields aside from vehicles where little unused space is available and it is difficult to provide space for installing conventional air conditioning blowers.

What is claimed is:

1. A centrifugal air blower in which a centrifugal fan and a motor that rotationally drives the centrifugal fan are housed inside a case body, and which draws in air from a center in an axial direction of the case body and expels the air from a bottom on an outside in a radial direction of the case body,
wherein the case body includes:
a first case that is assembled to cover the centrifugal fan, has an intake opening provided at a center thereof, and has a first air passage formed at an outside in the radial direction; and
a second case that rotatably supports the motor and has a second air passage that is combined with the first air passage and is formed radially outward of an outer circumferential end of the centrifugal fan,
wherein the motor is housed in a dome-shaped space formed on an opposite side to an intake opening by a hub of the centrifugal fan and a main plate that is continuous with the hub, in a state where the motor is stacked in the axial direction,
the first case and the second case combine to form an annular air passage around an outside in the radial direction of the case body,
an inner circumferential surface of the first air passage is provided with a first diffuser that is inclined diagonally downward from an inside in the radial direction toward an outside,
a plurality of exhaust holes, which expel compressed air outside the case body, are formed in a bottom of the second air passage at predetermined intervals in a circumferential direction, and
a second diffuser that is inclined diagonally downward with respect to a direction of rotation of the centrifugal fan is provided at positions that face the exhaust holes.

2. The centrifugal air blower according to claim 1,
wherein an inner wall surface of the first air passage is formed with an inclined surface that is inclined diagonally downward from an inside in the radial direction toward an outside, and
the first diffuser is formed with continuous arc-shaped ribs at predetermined intervals whose height gradually increases from a first imaginary circle that defines, in a plan view of the first case, an inner end in the radial direction of the inclined surface toward a second imaginary circle that defines an outer end in the radial direction of the inclined surface.

3. The centrifugal air blower according to claim 2,
wherein each rib is formed so that an angle θ formed between a first tangent line, which passes through an intersection where a radius of the first case and the first imaginary circle intersect, and a second tangent line, which is tangential to a rib that is arc-shaped and connects the intersection on the first imaginary circle and the second imaginary circle, is 0° to 90°.

4. The centrifugal air blower according to claim 1,
wherein diffusion plates that construct the second diffuser are disposed so that diffusion plates that are adjacent in the circumferential direction do not overlap each other in a plan view in the axial direction of the second case, and have a curved shape where a downstream end in a direction in which air is exhausted is shifted by a predetermined amount in the direction of rotation of the centrifugal fan so that air is exhausted in keeping with rotation of the centrifugal fan.
